(19) United States
(12) Patent Application Publication
(10) Pub. No.: US 2008/0062854 A1
(43) Pub. Date: Mar. 13, 2008

(54) Disc Recording Medium, Disc Drive, and Manufactuing Method of Optical Disc

(75) Inventors: Ariyoshi Nakaoki, Tokyo (JP); Masanobu Yamamoto, Kanagawa (JP); Kimihiro Saito, Saitama (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/628,357

(22) PCT Filed: Jun. 13, 2005
(86) PCT No.: PCT/JP05/10795

§ 371 Date: Dec. 4, 2006

(51) Int. Cl. G11B 19/00

(52) U.S. Cl. 369/218

(57) ABSTRACT

The present invention relates to an optical disc on which an information signal can be rewritten. Guide grooves (81a) for tracking control are formed on respective tracks of the rewritable area where an information signal can be rewritten. A recording layer (83) onto which an information signal is to be written is laminated on a substrate on which the guide grooves (81a) have been formed. The information signal can be rewritten on the recording layer (83) at least in the rewritable area using near-field light based on multibeam. Concave portions (85a) are formed on the outermost surface of the disc recording medium in correspondence with the positions of the guide grooves (81a).

than the DVD has now been developed. At the same time, the recording density of an HDD (Hard Disc Drive) is increasing year by year.

Along with the digitization and increase in resolution of image information and the improvement of communication performance of an optical communication, there has recently been an increased demand for further improvement of recording density and recording capacity of storage. A recording density of 1 Tbits/(inch)² is expected in 2010.

It is said that a recording density of an HDD is limited to 100 to 300 Gbpsi due to a superparamagnetic effect and difficulty in controlling the gap width of a magnetic head, and an optical assist magnetic recording technology is now expected to push the limit.

In the field of an optical recording medium, an optical recording using near-field light is expected to improve the recording density. The near-field light is non-propagation light existing within the area less than the diffraction limit of light which is located around a minute opening or a minute object. When a given object is brought close to the minute opening or minute object by a distance less than the diffraction limit, the near-field light is propagated to the object and, at the same time, interaction is induced. A leakage of such near-field light can be achieved by miniaturizing the minute opening or minute object. By irradiating an optical recording medium with the leaked near-field light, high-density optical recording can be performed. In the optical recording using the near-field light, recording and reproduction of information is performed with a single light spot following a guide groove or guide land, as in the case of the DVD or the like.

In order to record information onto an optical recording medium using the abovementioned near-field light, the information recording needs to be performed for a flat rewritable area where no groove has been formed. Particularly, in order to record information at a high density, the flat rewritable area needs to be increased.

In a conventional optical recording medium, a recording area is formed along the groove, and one guide groove corresponds to a near-field light spot. Therefore, in the case where many light spots are formed on the optical recording medium for the purpose of increasing the recording density, grooves corresponding to the number of the formed light spots need to be formed. However, the reality is that it is not easy to spirally cut the surface of a recording medium into grooves at fine pitches in correspondence with the many light spots.

In general, in order to form two parallel grooves on an optical recording medium, it is necessary to use two laser beams also at the cutting time, or to allow a light beam for high-speed cutting to wobble to thereby realize the two laser beams in a pseudo manner. As the number of the required grooves is increased to three, four, . . . , the degree of difficulty in the formation of the grooves increases proportionately.

In order to solve the above problem, an optical recording medium, a recording/reproduction apparatus, and the like in which the recording density and the transfer rate in the optical recording using the near-field light are improved have been proposed in Japan. Pat. Appln. Laid-Open Publication No. 2003-272176 and the like. The publication discloses a control method using a slide or levitation type slider attached to a swing arm. In the conventional example, an objective lens is driven along the surface of an optical recording medium, so that the objective lens is expected to be tilted or displaced with respect to an optical axis independently disposed. Particularly, in the case where information recording/reproduction is performed using the near-field light, the position of the objective lens with respect to the surface of the optical recording medium and near-field light spot is required to be accurate. Therefore, the tilt or displacement of the objective lens may become a barrier in achieving more reliable recording/reproducing processing.

Further, in some cases, a concave portion may be formed on the surface of an optical recording medium through recording/reproduction processing. Such a concave portion becomes a barrier for recording/reproduction processing using the near-field light rather than an advantage.

### DISCLOSURE OF INVENTION

The present invention has been made in view of the above problems, and it is desirable to provide a disc recording medium that can record/reproduce information using near-field light, which is capable of recording an information signal at a higher density as well as effectively utilizing a concave portion formed on the surface thereof to thereby execute various processing following the concave portion, and a disc drive capable of stably performing recording processing of an information signal at a higher density in the case where the disc recording medium of the present invention is inserted thereinto.

According to the present invention, there is provided a disc recording medium in which guide grooves for tracking control have been formed on tracks of a rewritable area where an information signal can be rewritten, in which a recording layer onto which the information signal is to be written is laminated on a substrate signal on which the guide grooves have been formed, and the information signal can be rewritten on the recording layer at least in the rewritable area using near-field light based on a multibeam, and concave portions are formed on the outermost surface of the disc recording medium in correspondence with the positions of the guide grooves.

Further, according to the present invention, there is provided a disc drive which performs recording/reproduction processing for a disc recording medium in which guide grooves for tracking control have been formed on tracks of a rewritable area where an information signal can be rewritten, including a control section having a two-axis actuator for leaking near-field light serving as the information signal onto the rewritable area using a multibeam and a drive controller for moving the two-axis actuator to a desired track position, wherein when the disc recording medium including a substrate having the guide grooves, on which a recording layer onto which the information signal is to be written is laminated at least in the rewritable area and having, on the outermost surface thereof, concave portions formed in correspondence with the positions of the guide grooves is inserted into the disc drive, the control section controls the two-axis actuator through the drive controller such that spot rows of the near-field light are arranged in correspondence with the positions of the concave portions.

In the disc recording medium according to the present invention, a recording layer onto which the information signal is to be written is laminated on a substrate signal on which the guide grooves have been formed, the information signal can be rewritten on the recording layer at least in the rewritable area using near-field light based on a multibeam, and concave portions are formed on the outermost surface of the disc recording medium in correspondence with the positions of the guide grooves. Thus, by forming a plurality of near-field light spots when an information signal is rewritten using the near-filed light based on a multibeam, high density recording processing can be achieved. That is, in the case where reproduction/recording is performed using the near-field light, a distance (air layer) between the lens focusing light beam and the outermost surface of the disc influences the signal intensity. Therefore, the guide grooves are formed into a concave shape and a protection film is formed along the grooves. This increases the thickness of the air layer, making it easy to acquire the signal of the guide grooves. Further, a recording surface is formed into a convex shape, and guide grooves are formed at predetermined pitches for receiving a multibeam. This allows a recoding area to be widely formed at the portion near the lens, making it easy to form the near-field. Thus, the present invention is useful to an optical disc that performs recording/reproduction of information using near-filed light based on a multibeam.

The above and other objects, advantages and features of the present invention will be more apparent from the following description taken in conjunction with the accompanying drawings.

### BRIEF DESCRIPTION OF DRAWINGS

FIG. 1 is a block circuit diagram showing an optical recording apparatus according to the present invention;

FIG. 2 is a side view of a lens block included in the optical recording apparatus;

FIG. 3 is a characteristic curve diagram showing the relationship between the amount of returning light and distance between gaps,

FIG. 4 is a partial cross-sectional view showing an optical disc onto which a signal is recorded by the optical recording apparatus according to the present invention;

FIG. 5 is a cross-sectional view showing an example in which near-field light based on a multibeam is leaked onto a signal recording surface in a lens block mounted in the optical recording apparatus according to the present invention;

FIG. 6 is a view showing light spots formed by the near-field light from the lens block as viewed in D direction in the FIG. 5;

FIG. 7 is a plan view of the optical disc on which guide grooves are formed in a zig-zag fashion;

FIG. 8 is a plan view showing an example in which four light spots are formed at a time on the optical disc; and

FIGS. 9A to 9G are cross-sectional views sequentially showing a manufacturing process of the optical disc; FIG. 9A shows a state where the surface of a glass substrate is polished and washed; FIG. 9B shows a state where a photoresist is coated on the washed surface of the glass substrate, FIG. 9C shows a state where laser light that is modulated by groove information is irradiated on the photoresist to record a groove pattern; FIG. 9D shows a state where the glass substrate is developed; FIG. 9E shows a state where nickel is deposited on the surface of the glass substrate to form a nickel plating layer; FIG. 9F shows a state where a stamper constituted by the nickel plating layer is used to from a disc substrate; and FIG. 9G shows the optical disc on which a recording layer and protection film are formed.

### BEST MODE FOR CARRYING OUT THE INVENTION

An embodiment of the present invention will be described in detail below with reference to the accompanying drawings.

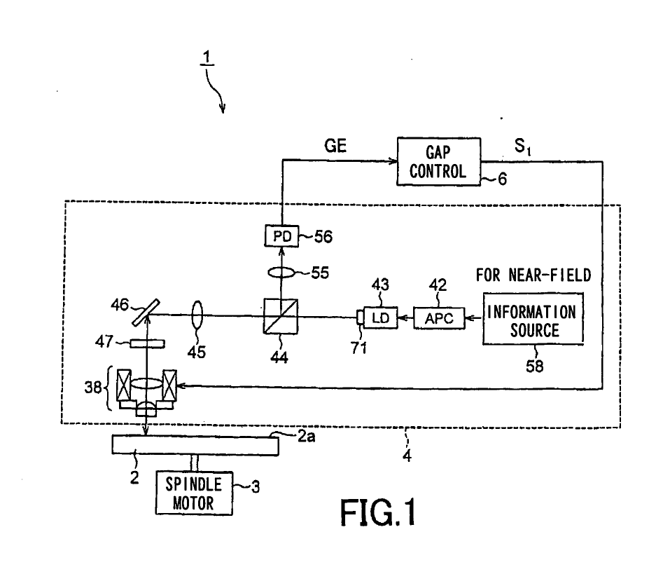

A disc drive according to the present invention will be described first. As shown in FIG. 1, an optical recording apparatus 1, which is an apparatus detachably receiving an optical disc 2 therein as a recording medium, includes: a spindle motor 3 for rotating the optical disc 2 to be detachably mounted in the optical recording apparatus 1; an optical head 4 for irradiating a signal recording surface 2a of the optical disc 2 with laser light and detecting the returning laser light reflected by the signal recording surface 2a of the optical disc 2; and a gap controller 6 for generating a control signal S₁ based on the returning laser light detected by the optical head 4.

A disc table on which the optical disc 2 is mounted is integrally attached to the spindle motor 3. The spindle motor 3 rotates a drive shaft at, e.g., CLV (Constant Liner Velocity) or CAV (Constant Angular Velocity) based on a spindle motor drive signal supplied from a not-shown system controller to thereby rotate the optical disc 2 mounted on the disc table.

The optical head 4 focuses a light beam onto respective recording layers of the optical disc 2 rotated by the drive of the spindle motor 3 and detects the returning light reflected by the signal recording surface 2a of the optical disc 2 so as to output it to a not-shown signal processing section. At this time, the optical head 4 is controlled so as to emit laser light having an optimum wavelength for the optical disc 2 depending on the type of the optical disc 2.

The gap controller 6 generates a control signal S₁ based on a gap error signal GE sent from the optical head 4 and outputs it to the optical head 4. That is, with this control signal S₁, it is possible to fine-adjust the position of the objective lens provided in the optical head 4 in the direction toward and away from the optical disc 2.

In the optical recording apparatus 1, a not-shown access mechanism moves the optical head 4 in the radial direction of the optical disc 2 and controls the movement of the optical head 4 such that the optical head 4 is positioned on a predetermined recording track formed on the optical disc 2.

Details of the optical head 4 used in the optical recording apparatus 1 according to the present invention will next be described.

As shown in FIG. 1, the optical head 4 includes: an APC (Automatic Power Controller) 42 which controls the drive current of a semiconductor laser that can emit a multibeam laser light; a holder 43 which supports the semiconductor lasers; a beam splitter 44 disposed in the light path of the multibeam laser light emitted from the semiconductor laser; a collimator lens 45 which makes the emitted beams of laser light transmitting through the beam splitter 44 parallel to each other; a mirror 46 disposed in the light path of the laser light whose beams are made parallel to each other by the collimator lens 45; a ¼ wavelength plate 47 which receives the laser light reflected by the mirror 46; a lens block 38 which focuses the laser light passing through the ¼ wavelength plate 47 on the signal recording surface 2a of the optical disc 2; a focusing lens 55 which focuses the returning light reflected by the signal recording surface 2a on the optical disc 2; and a light receiving element 56 which receives the returning light.

A semiconductor laser 71 which emits a multibeam laser light having a predetermined wavelength is attached to the holder 43. The semiconductor laser 71 is a light emitting element utilizing the recombination emission of a semiconductor. The semiconductor laser 71 emits laser light based on an information signal supplied from an information source 58 with the drive current thereof controlled by the APC 42 such that the output of the laser light is constant.

The beam splitter 44 allows the laser light emitted from the semiconductor laser 71 to transmit therethrough so as to guide the laser light to the optical disc 2, and reflects the returning light reflected by the optical disc 2 so as to guide the light to the light receiving element 56. The beams of the laser light, which is divergent light transmitting through the beam splitter 44, are made parallel to each other by collimator lens 45 and then transmitted through the ¼ wavelength plate 47. In the case where the laser light emitted from the semiconductor laser 71 contain any polarized light, the beam splitter 44 uses a polarizing beam splitter to thereby prevent the returning light reflected by the optical disc 2 from returning to the semiconductor laser 71.

The mirror 46 reflects the laser light transmitting through the beam splitter 44 to fold the light path. The laser light then perpendicularly irradiates the signal recording surface 2a of the optical disc 2 disposed below the optical head 4.

The ¼ wavelength plate 47 gives a π/2 phase difference to the laser light passing therethrough. The linearly-polarized light emitted from the semiconductor laser 71 passes through the ¼ wavelength plate 47 to thereby become circularly-polarized light. The returning circularly-polarized light reflected by the optical disc 2 becomes linearly-polarized light, if passing through the ¼ wavelength plate 47.

The lens block 38, which is disposed in the light path of the laser light reflected by the mirror 46, has a function of focusing the laser light and irradiating the signal recording surface 2a of the optical disc 2 with the focused laser light. The lens block 38 is so supported as to be movable in two axial directions, i.e., direction toward and away from the optical disc 2 and radial direction of the optical disc 2, by a two-axis actuator that the lens block 38 itself has. The lens block 38 is moved by the two-axis actuator based on the control signal S₁ generated by the returning light from the optical disc 2, thereby realizing focusing control.

The laser light focused on the signal recording surface 2a of the optical disc 2 is reflected by the signal recording surface 2a and passes through the lens block 38 to become parallel light. The returning light reflected by the optical disc 2 first passes through the ¼ wavelength plate 47 and then passes through the collimator lens 45 to become focusing light, which is then reflected by the beam splitter 44.

The light receiving elements 56 receives the laser light that has been reflected by the beam splitter 44 and focused by the focusing lens 55, applies photoelectric conversion to the received light to generate gap error signals GE to be described later, and supplies the gap error signals GE to the gap controller 6. Incidentally, by preparing detection patterns corresponding to the number of light spots of the multibeam laser light on the light receiving element 56, it is possible to acquire the gap error signals as individual signal lights independently of each other. The optimization of the detection patterns formed on the light receiving element 56 allows the light spots to be detected based on, e.g., a push-pull method.

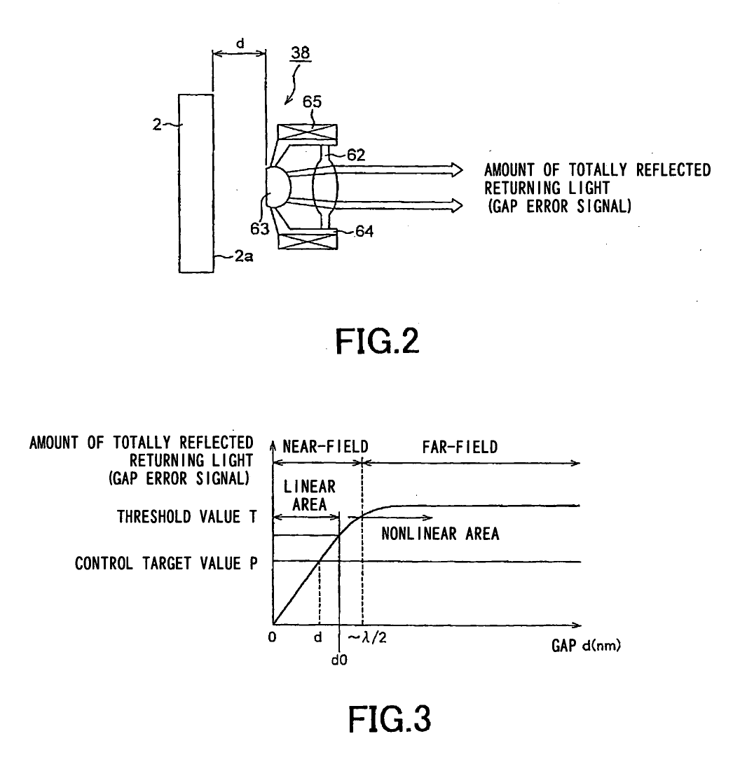

Details of the lens block will next be described. The lens block 38, which is disposed in the light path of the laser light reflected by the mirror 46, includes an objective lens 62, an SIL (Solid Immersion Lens) 63, a lens folder 64, and a two-axis actuator 65, as shown in FIG. 2.

The objective lens 62 is an aspherical lens having a function of focusing the laser light and supplying the focused light to the SIL 63. The SIL 63 is a high refractive index lens formed into a shape obtained by cutting a part of a spherical lens so as to form a flat surface. The SIL 63, which is disposed near the signal recording surface 2a, receives the laser light supplied from the objective lens 62 from its spherical surface side and focuses the received light on the central portion of the surface (edge surface) on the opposite side to the spherical surface.

In the lens block 38, an SIM (Solid Immersion Mirror) including a reflection mirror can be used in place of the SIL 63.

The lens folder 64 holds the object lens 62 and the SIL 63 in a predetermined positional relationship. The SIL 63 is held by the lens folder 64 such that its spherical surface side faces the objective lens 62 and the surface (edge surface) on the opposite side to the spherical surface faces the signal recording surface 2a of the optical disc 2.

By disposing the high refractive index SIL 63 between the objective lens 62 and signal recording surface 2a using the lens folder 64 as described above, it is possible to obtain an NA greater than that provided only by the objective lens 62. In general, the spot size of the laser light emitted from the lens is inversely proportional to the NA of the lens, so that the spot size of the laser light can be made minute by the objective lens 62 and the SIL 63.

The two-axis actuator 65 moves the lens folder 64 in the focus direction in response to a control voltage output as the control signal S₁ from the gap controller 6.

A part of the laser light that has entered the edge surface of the SIL 63 at an angle more than a critical angle and then totally reflected is leaked from the reflecting boundary. This leaked light is defined as an evanescent light in the lens block 38. In the case where the edge surface is positioned within the near-field (to be described later) of the signal recording surface 2a of the optical disc 2, the above-mentioned evanescent light leaked from the edge surface of the SIL 63 irradiates the signal recording surface 2a.

Subsequently, a description will be given of the near field. The near-field is an area defined by the following equation: d≦λ/2, where the distance (gap) between the edge surface of the SIL 63 and signal recording surface 2a of the optical disc 2 is d, and the wavelength of the laser light entering the SIL 63 is λ. That is, a state where the gap d defined by the distance between the signal recording surface 2a of the optical disc 2 and the edge surface of the SIL 63 satisfies d≦λ/2 and where the evanescent light is leaked from the edge surface of the SIL 63 onto the signal recording surface 2a of the optical disc 2 is called “near-field state”; on the other hand, a state where d satisfies d>λ/2 and where the evanescent light is not leaked onto the signal recording surface 2a is called “far-field state”.

In the far-field state, the light that has entered the edge surface of the SIL 63 at an angle more than the critical angle is totally reflected to become returning light. Thus, as shown in FIG. 3, the amount of the returning light in the far-field state is constant.

In the near-field state, a part of the light that has entered the edge surface of the SIL 63 at an angle more than the critical angle is, as described above, leaked onto the signal recording surface 2a of the optical disc 2 from the edge surface of the SIL 63, i.e., the reflecting boundary, as the evanescent light. Thus, as shown in FIG. 3, the amount of the totally-reflected returning light is reduced as compared to the returning light in the far-field state. The amount of the returning light in the near-field state is reduced as the distance between the edge surface of the SIL 63 and disc 2 becomes smaller.

In the near-field state, the area where the amount of the returning light is linearly changed with respect to the gap length is called the “linear area”, and the area where the amount of the returning light is nonlinearly changed with respect to the gap length is called the “nonlinear area”. Thus, in the case where the position of the edge surface of the SIL 63 is in the near-field state and belongs to the linear area, it is possible to control the gap to be constant by receiving the returning light and applying photoelectric conversion to the received light using the light receiving element 56 to generate gap error signals GE and performing feedback servo based on the gap error signals GE. That is, when the amount of the returning light is controlled so as to be a control target value P as shown in FIG. 3, it is possible to keep the gap d at a constant value.

Although the combination of the objective lens 62 and SIL 63 that constitute the lens folder realizes a high NA state of NA=1.83, the embodiment of the invention is not limited this particular case, and it is possible to leak the near-field light as long as the NA is 1.0 or more.

Since the edge surface is brought close to the signal recording surface 2a such that the gap d in the lens block 38 having the above configuration becomes λ/2 or less, when a land is formed as an alternative for a guide groove, the edge surface 2a may collide with the land at scanning time. Thus, the guide groove is formed in a concave shape, the advantage of the present invention becomes more effective.

As described above, in the optical recording apparatus 1 of the present invention, the two-axis actuator 65 can be used to perform the focus control, so that more reliable processing can be realized in the recording/reproduction using the near-field light, where the position of the objective lens with respect to the light spot is required to be accurate.

The details of the configuration of the optical disc 2 that records an information signal by means of the optical recording apparatus 1 according to the present invention will be described next.

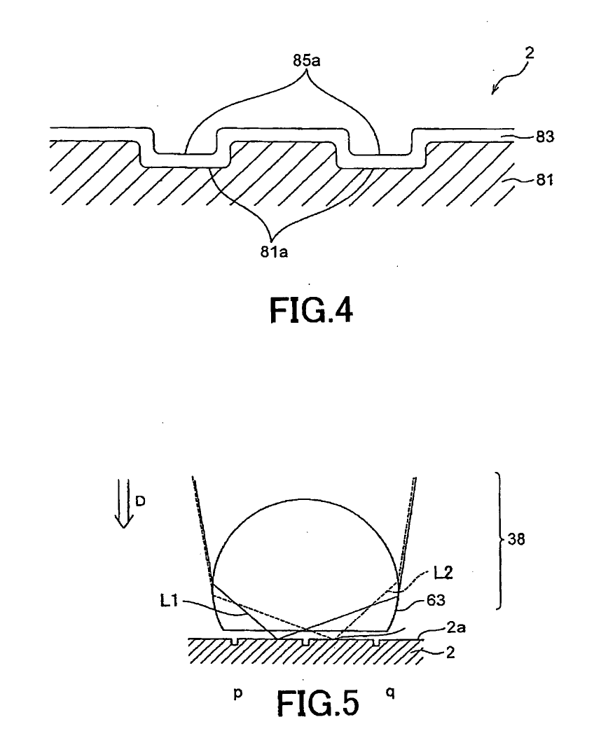

As shown in FIG. 4, which schematically shows the surface of the optical disc 2, the optical disc 2 includes a base plate 81, guide grooves 81a formed on the base plate 81, and at least a recording layer 83 coated on the base plate 81.

The base plate 81 is made of, e.g., polycarbonate. Using electron beam to expose the surface of the base plate 81 allows easy formation of the guide grooves 81a into nanometer widths. That is, the base plate 81 can be produced easily using a current mastering apparatus.

The recording layer 83 is formed by a phase change recording film made of GeSbTe. In the case where the recording film 83 is formed by a magneto-optical recording film, the film 83 is made of, for example, TbFeCo.

Minute concave portions 85a are further formed on the outermost surface of the optical disc 2 at the portions corresponding to respective guide grooves 81a. It is possible to effectively form the concave portions 85a by using a solid and inorganic film such as DLC (Diamond Like Carbon) or ultraviolet curable resin as a layer up to the outermost surface of the optical disc 2 as compared to the case where a resist film or the like is used.

It is preferable that the number of the concave portions 85a be reduced as much as possible to increase the flat area in the case where high density optical recording is performed using the near-field light. The optical recording apparatus 1 using the multibeam is advantageous in that the ratio of the area of the guide grooves 81a relative to the number of light spots to be formed can be reduced as much as possible, leading to an increase in the recording density.

The concave portion 85a has a depth of, e.g., 30 nm and a width of about 80 nm. However, the size of the concave portion 85a is not limited to these particular values.

That is, in the optical recording apparatus 1 according to the present invention, the near-field light spots are formed on the optical disc 2 on the outermost surface of which the concave portions 85a have been formed, thereby realizing recording processing. Further, various operations following the concave portions 85a can be executed. Additionally, acquisition of a guide track signal can be realized using the concave portions 85a. When the concave portions 85a are formed depending on the position of the abovementioned guide grooves 81a, the above advantages are achieved.

A description will be given of the case where the optical recording apparatus 1 irradiates the optical disc 2 having the above configuration with the near-field light based on the multibeam.

FIG. 5 shows an example in which the near field light based on the multibeam is leaked onto the signal recording surface 2a in the lens block 38 having the above configuration. The near-field light based on a first laser light L1 (denoted by a solid line) is irradiated on a point P on the signal recording surface 2a. The near-field light based on a second laser light L2 (denoted by a dotted line) is irradiated on a point q on the signal recording surface 2a.

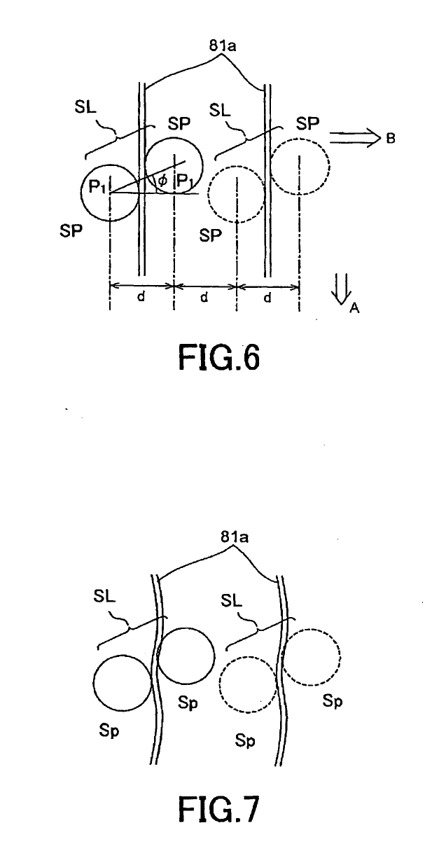

FIG. 6 shows light spots Sp formed by the near-field light from the lens block as viewed in D direction in FIG. 5. As shown in FIG. 6, the light spots Sp of the multibeam are arranged in a line so as to sandwich the respective guide grooves 81a arranged perpendicular to the movement direction of the optical disc 2. The angle φ of a line connecting centers P1 of the light spots Sp relative to the guide groove 81a can be any value. By previously identifying the angle φ, the distance between the light spots Sp can be acquired, thereby ensuring an advantage of the signal processing in subsequent stages.

Assume that the distance between the respective light spots Sp of the multibeam in the radial direction B of the optical disc 2 is set to d in FIG. 6. In this case, when the width of the guide groove 81a is set to a value less than d, it is possible to detect tracking information from a change in the light amount of both the light spots Sp. For example, the detection of a push-pull signal allows the tracking information to be acquired.

The guide groove 81a may be formed in a zig-zag fashion, as shown in FIG. 7. That is, it becomes possible to perform signal detection from a light spot row SL including two light spots Sp formed across the guide groove 81a which has been snaked based on information such as a clock or address. That is, the two light spots Sp are used to calculate a difference between the returning light and the guide groove 81a, and the calculated value is given to the two-axis actuator 65 as an error signal to realize the tracking as described above.

In the case where the guide groove 81a is depicted in a spiral manner, for example, under the condition that the optical spot Sp is allowed to follow the guide groove 81a, the light spot row SL is shifted from the position denoted by a solid line to the position denoted by a dotted line, as shown in FIGS. 6 and 7 after one full rotation of the optical disc 2.

The pitch between the guide grooves 81a may be controlled to be n×d, assuming that a light spot row including n light spots is formed. Thus, even if a line connecting the center P₁ of the light spots Sp is perpendicular to the guide groove 81a, irradiation positions of the light spots Sp are not overlapped with each other, allowing effective recording/reproduction processing to be performed for the optical disc 2.

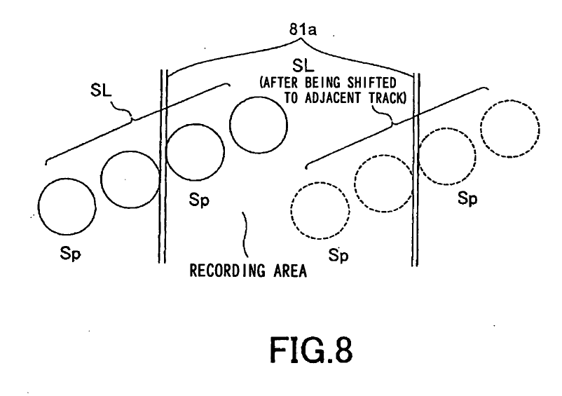

FIG. 8 shows an example in which four light spots Sp are formed on the optical disc 2 at a time. As shown in FIG. 8, two light spots Sp are formed on the respective sides of the guide groove 81a. When the guide groove 81a is depicted in a spiral manner, the light spots Sp are shifted from the positions denoted by solid lines to the positions denoted by dotted lines as shown in FIG. 8 after one full rotation of the optical disc 2. It is preferable that the ratio of the number of light spots Sp formed on both sides of the guide grooves 81a be 1:1. However, the ratio is not limited to this, but may be set to any value. For example, a configuration in which one light spot Sp is formed on one side of the guide groove 81a and three light spots Sp are formed on the other side thereof may be employed. Further, a configuration in which four light spots are arranged only on one side of the guide groove 81a may be employed as long as the light spots Sp are formed in correspondence with the position of the guide groove 81a. The number of the light spots Sp to be formed may be any value as long as it is more than one.

In this case, according to n×d, the pitch between the guide grooves 81a is controlled to 4d, that is, a value more than the size corresponding to four light spots. Thus, irradiation positions of the light spots Sp are not overlapped with each other, allowing effective recording/reproduction processing to be performed for the optical disc 2.

A manufacturing process of the recording optical disc according to the present invention will next be described.

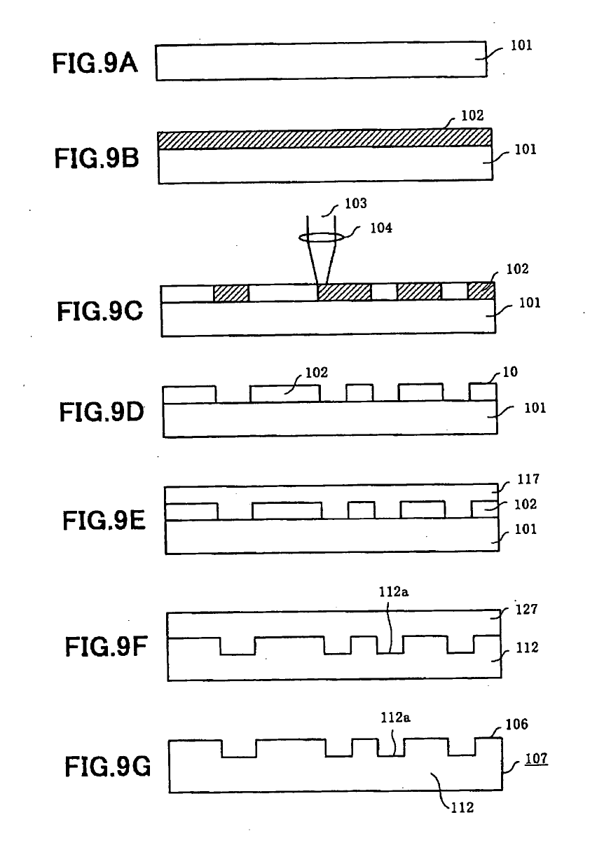

As shown in FIG. 9A, a glass substrate 101 is prepared, and the surface of the glass substrate 101 is polished and washed for manufacturing the optical disc 2 according to the invention. Subsequently, as shown in FIG. 9B, a photoresist 102 is coated on the washed surface of the glass substrate 101. After that, as shown in FIG. 9C, laser light 103 modulated based on groove information is focused by an objective lens 104 and irradiated onto the photoresist 102 to record a groove pattern. In this case, near-field light may be used as the laser light irradiated onto the photoresist 102.

After the recording of the groove pattern has been completed as described above, the glass substrate 101 is developed as shown in FIG. 9D. At this time, only a part of the photoresist 102 that is irradiated with the laser light is dissolved by the developing solution. As a result, a pattern corresponding to a pattern to be formed on the recording surface is formed on the glass substrate 101.

Subsequently, as shown in FIG. 9E, nickel is deposited on the surface of the glass substrate 101 on which the pattern has been formed through the developing processing to thereby form a nickel plating layer 117. After that, the nickel plating layer 117 is separated from the glass substrate 101, and the pit and projection pattern formed on the glass substrate 101 is transferred to the nickel plating layer 117. The nickel plating layer 117 on which the pit and projection pattern has been formed is used as a stamper for forming a disc substrate constituting an optical disc.

A stamper 127 constituted by the nickel plating layer 117 is attached to, e.g., an injection molding machine. Then the injection molding machine is used to form a synthetic resin material. As a result, as shown in FIG. 9F, a disc substrate 112 on which a groove pattern 112a which is the pit and projection pattern formed on the surface of the stamper 127 and which has been transferred is formed.

A recording film 105 is formed on the disc substrate 112 on the surface of which the groove pattern 112a has been formed. Further, a transparent protection film 106 is deposited on the recording film 105. As a result, a recording optical disc 107 as shown in FIG. 9G is obtained.

The recording film 105 of the optical disc 107 is formed using a material on which information can be recorded and rewritten by irradiation of a light beam. For example, the recording film 105 is formed by a phase change recording film made of GeSbTe or a magnetooptical recording film made of TbFeCo or the like.

It is preferable that the protection film 106 be formed by a solid and inorganic film such as DLC (Diamond Like Carbon). Alternatively, the protection film 106 may be formed by ultraviolet curable resin.

Although the optical recording apparatus 1 according to the present invention is configured to record a signal based on the two modes, i.e.,_—near-field and far-field, the present invention may be applied to an apparatus that uses only the near-field mode to record a signal. As a matter of course, a configuration in which the optical recording apparatus 1 according to the present invention is used to reproduce a signal recorded on the optical disc 2 may be adopted.

The present invention is not limited to the embodiment described above by using the accompanied drawings, but various modifications, substitutions, or equivalents will readily occur to persons in the art without deviating from the appended claims and the scope of subject matters thereof.

1. A disc recording medium in which guide grooves for tracking control have been formed on tracks of a rewritable area where an information signal can be rewritten, wherein
a recording layer onto which the information signal is to be written is laminated on a substrate on which the guide grooves have been formed,
the information signal can be rewritten on the recording layer at least in the rewritable area using near-field light based on a multibeam, and
concave portions are formed on the outermost surface of the disc recording medium in correspondence with the positions of the guide grooves.

2. The disc recording medium according to claim 1, wherein the guide grooves are each formed in a width of less than the spot pitch d of the near-field light based on the multibeam, and arranged in a pitch more than d×n, assuming that the number of spots is n.

3. The disc recording medium according to claim 1, wherein a layer up to the outermost surface of the disc recording medium is formed by a DLC (Diamond Like Carbon) film.

4. The disc recording medium according to claim 1, wherein the guide grooves are formed in a zig-zag fashion.

5. A disc drive which performs recording/reproduction processing for a disc recording medium in which guide grooves for tracking control have been formed on tracks of a rewritable area where an information signal can be rewritten, comprising:
control means having a two-axis actuator for leaking near-field light serving as the information signal onto the rewritable area using multibeam and a drive controller for moving the two-axis actuator to a desired track position, wherein
when the disc recording medium including a substrate having the guide grooves, on which a recording layer onto which the information signal is to be written is laminated at least in the rewritable area and having, on the outermost surface thereof, concave portions formed in correspondence with the positions of the guide grooves is inserted into the disc drive, the control means control the two-axis actuator through the drive controller such that spot rows of the near-field light are arranged in correspondence with the positions of the concave portions.

6. The disc drive according to claim 5, wherein the two-axis actuator of the control means includes an objective lens for focusing supplied light and leaking the near-field light, and the NA of the objective lens is set to 1.0 or more.

7. A manufacturing method of an optical disc having a rewritable area where information can be rewritten using near-field light based on multibeam, comprising the steps of:
forming, on a substrate, guide grooves for tracking control on respective tracks formed in the rewritable area;
forming, on the substrate on which the guide grooves have been formed, a recording layer for recording an information signal using near-field light based on multibeam at least in the rewritable area; and
forming, on the surface of the substrate, concave portions in correspondence with the positions of the guide grooves.
